(19) United States
(12) Patent Application Publication
(10) Pub. No.: US 2019/0106520 A1
(43) Pub. Date: Apr. 11, 2019

(54) UV-ABSORBING POLYMERIC PARTICLES

(71) Applicant: BAR-ILAN RESEARCH & DEVELOPMENT COMPANY LTD, Ramat Gan (IL)

(72) Inventors: Shlomo MARGEL, Rehovot (IL); Sarit COHEN, Peduel (IL)

(21) Appl. No.: 16/086,914

(22) PCT Filed: Mar. 28, 2017
(86) PCT No.: PCT/IL2017/050386

§ 371 Date: Sep. 20, 2018

Related U.S. Application Data
(60) Provisional application No. 62/313,842, filed on Mar. 28, 2016.

(51) Int. Cl. C08F 220/36; C09D 133/14; C08J 7/04; B65D 65/42

(52) U.S. Cl. CPC C08F 220/36; C09D 133/14; C08J 2433/14; B65D 65/42; C08J 7/047

(57) ABSTRACT

Microparticles and Nanoparticles crosslinked polymer derived from 2-(2′-hydroxy-5′-methacryloxyethylphenyl)-2H-benzotriazole or a derivative thereof, are disclosed. Process of preparing the polymeric nanoparticles per se and incorporated in or on a substrate are also disclosed. Uses of the polymeric nanoparticles and of substrates incorporating same, particularly for UV absorbing films, are also disclosed.

This application claims the benefit of priority from U.S. Provisional Patent Application No. 62/313,842, filed on Mar. 28, 2016. The content of the above document is incorporated by reference in its entirety as if fully set forth herein.

### FIELD OF THE INVENTION

The present invention, in some embodiments thereof, relates to crosslinked polymeric backbones, and more particularly, but not exclusively, to microsized and nanosized polymeric particles derived from 2-(2′-hydroxy-5′-methacryloxyethylphenyl)-2H-benzotriazole or a derivative thereof, and uses thereof in, for example, UV absorbing films.

### BACKGROUND OF THE INVENTION

Ultraviolet (UV) radiation is responsible for the photo destruction, discoloration and the loss of mechanical properties of polymers and plastics. In addition, UV radiation can adversely affect substances within the plastic such as food and beverages, pharmaceutical products, household, cosmetic and personal care products, by leading to color fading of food, accelerated oxidation of oils and fats and loss of vitamin content in fruit juice and milk. Therefore, protecting light sensitive materials against UV irradiation is important technological demand in almost every industrial field.

Protection against photo degradation can be achieved by coating of UV absorbers (UVA), reducing thereby degradation upon exposure to UV light. Inorganic and organic materials can be used for this purpose. One of the most important families of organic UVA molecules comprises a phenol functional group that participates in the dissipation of the absorbed energy by a non-radiative process, such as 2-(2-hydroxyphenyl)-1,3,5-triazines and 2-(2-hydroxyphenyl) benzotriazoles. The benzotriazole UV absorbers, which have a phenolic group attached to the benzotriazole structure, are known to absorb the full spectrum of UV light and are used in a variety of plastic products. Although small molecule UV absorbers of various types are effective in inhibiting the photo destruction of the polymers to which they are added, they tend to migrate from polymers over time or upon irregular conditions, e.g., exposure to solvents and/or high temperatures. This fact may serves as a significant disadvantage, since the fabrication and processing of the polymers is performed at elevated temperatures.

Optimal crosslinked polymeric nanoparticles (NPs) or microparticles (MPs) based on organic UVA may overcome this disadvantage, due to their insolubility and large spatial structure which limits them from migrating while maintaining their activity. Hence, using appropriate particles as an additive to films will result in resistance to degradation upon exposure to UV light, with decreased extractability and volatility. In addition, aqueous dispersion of these NPs or MPs, may provide an environmental advantage, e.g., the avoidance of volatile organic solvents.

Polyolefins are plastic materials useful for making a wide variety of products. One of the most valued products is plastic films. Plastic films such as polypropylene (PP) films are in use in packaging applications but they also find utility in the agricultural, medical and engineering fields. For some uses such as packaging applications, the optical properties (haze, clarity and total visible light transmittance) of the films are critical to end-use. Ideally, thin coating of appropriate particles onto plastic films, may result in completely absorb UV light plastic of complete transparency of visible light, low haze and high clarity values.

Reinforced polymeric (e.g., polyolefin) films are widely used in many industrial applications.

Generally, such composite materials have been manufactured by melt compounding of reinforcements and fillers with neat plastic materials, occasionally with stabilizers.

### SUMMARY OF THE INVENTION

The present invention, in some embodiments thereof, relates to crosslinked polymeric backbones, and more particularly, but not exclusively, to microsized and nanosized polymeric particles comprising 2-(2′-hydroxy-5′-methacryloxyethylphenyl)-2H-benzotriazole or a derivative thereof, and uses thereof in, for example, UV absorbing films.

According to an aspect of some embodiments of the present invention, there is provided a composition-of-matter comprising a plurality of crosslinked polymeric backbones, the crosslinked polymeric backbones being represented by the general Formula A:

[A₁]ₓ[A₂]_{y}

wherein:
(a) A₁ is a monomeric unit derived from a compound being represented by the general formula I:

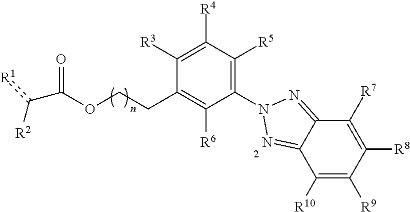

wherein each of R¹-R¹⁰ represents a substituent, such that:

R¹ is alkyl, substituted or non-substituted;
R² to R¹⁰, in each instance, comprise or are selected from the group consisting of hydrogen, alkyl, cycloalkyl, aryl, heteroalicyclic, heteroaryl, alkoxy, hydroxy, thiohydroxy, thioalkoxy, aryloxy, thioaryloxy, amino, nitro, halo, trihalomethyl, cyano, amide, carboxy, sulfonyl, sulfoxy, sulfinyl, sulfonamide, or is a fused ring;
n is an integer having a value from 1 to 5;
dot lines represent a double bond; and
(b) A₂ represents a cross-linker monomer,

wherein A₁ is polymerized, or is cross linked by at least one A₂, via the double bond; and wherein x and y are integers, independently, representing the total numbers of A₁ and A₂, respectively, in the plurality of crosslinked polymeric backbones, the x and the y having a value of at least 5.

In some embodiments, at least one of R³ to R⁵ is hydroxyl.

In some embodiments, A₁ is in the form represented by Formula Ib:

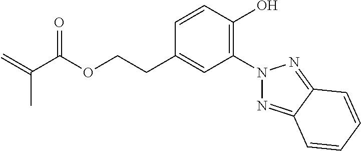 [SMILES: C=C(C)C(=O)OCCc1ccc(O)c(-n2nc3ccccc3n2)c1]

In some embodiments, the cross linker is selected from the group consisting of: tetra (ethylene glycol) diacrylate, ethylene glycol and dimethacrylate, divinylbenzene.

In some embodiments, the composition-of-matter is in the form of a particle.

In some embodiments, the particle is characterized by at least one dimension thereof having a size of less 100 nm.

In some embodiments, the particle is characterized by at least one dimension thereof having a size of 100 nm to 500 nm.

In some embodiments, at least 80% of a plurality of the particle is characterized by a size that varies within a range of less than 20%.

In some embodiments, the composition-of-matter, in any embodiment thereof, further comprises a substrate, wherein a plurality of the particle is incorporated or coated in/on at least a portion of the substrate.

In some embodiments, the substrate is selected from the group consisting of polypropylene (PP), polycarbonate (PC), polyethylene (PET), high-density polyethylene (HDPE), low-density polyethylene (LDPE), polyester (PE), and any combination thereof.

In some embodiments, a plurality of the particle forms a layer in/on a surface of the substrate.

In some embodiments, the crosslinked polymeric backbones, is represented by the general Formula B:

[A₁]ₓ[A₂]_{y}[A₃]_{z}

wherein A₃ represents a monomeric unit selected from the group consisting of isothiouronium methylstyrene (ITMS), methylstyrene farmin (MSF), methylstyrene farmin (MSF), wherein z is an integer, having a value of 1, or more.

In some embodiments, the layer is provided by a means selected from: bar spreading, immersing, thin coating, melt-mixing, doping and/or dipping of the particles on/with the substrate.

In some embodiments, the layer is characterized by a dry thickness of 0.5 to 20 microns.

In some embodiments, the composition-of-matter is characterized by light transparencies in the range of 0% to 40% at 200 nm to 380 nm wavelength.

In some embodiments, the composition-of-matter is characterized by a stable pattern of the light transparencies, the stable pattern varying within an average range of less than ±20% for a period of at least five years.

In some embodiments of the disclosed composition, the plurality of the particle is less than 4%, by total weight.

In some embodiments, the composition-of-matter is characterized by a haze value of less than 5%.

In some embodiments, the substrate is or forms a part of an article.

In some embodiments, the article is food packaging.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-D are photo images showing: polyNorbloc (PNB) nanoparticles (NPs) and microparticles (MPs) aqueous dispersion (FIG. 1A); Mayer rod coating setup for coating of the polypropylene (PP) films with PNB NPs or MPs (FIG. 1B) (the PP film is put on a flat plate and a Meyer rod is pulled over the film, which leaves a uniform thin layer of the PNB NPs or MPs on PP, denoted as “PP/PNB”); PP/PNB NPs and MPs films, (FIGS. 1C and 1D, respectively).

FIGS. 2A-D show hydrodynamic size histograms (FIGS. 2A&C) and scanning electron microscope (SEM) images (Figures B&D) of the PNB NPs and MPs prepared as described in the Example section.

FIG. 3 shows transmission electron microscopy (TEM) image of the PNB NPs.

FIGS. 4A-D present graphs showing X-ray diffraction (XRD) patterns (FIG. 4A), Fourier transform infrared (FTIR) spectra (FIG. 4B) and thermogravimetric analysis (TGA) (FIG. 4C) of the NB monomer and the PNB NPs prepared as described in the Examples section, with FIG. 4D further showing the TGA graph of the PNB MPs.

FIG. 5 presents a graph showing the effect of the initiator concentration on the size and size distribution of PNB NPs prepared as described in the experimental part.

FIG. 6 presents a graph showing the effect of the total monomer concentration on the size and size distribution of the PNB NPs prepared as described in the Examples section.

FIG. 7 presents a graph showing the effect of the surfactant concentration on the size and size distribution of PNB NPs prepared as described in the Examples section.

FIG. 8 presents a graph showing the effect of crosslinker concentration on the size and size distribution of PNB NPs prepared as described in the experimental part.

FIGS. 9A-B presents synthesis scheme (FIG. 9A) and photograph (FIG. 9B) of: the PNB NPs/MPs. NB was co-polymerized with divinylbenzene by emulsion and dispersion polymerization processes to obtain PNB nanoparticles and microparticles, respectively (designated by “A”). The emulsion polymerization resulted in a translucent NP dispersion, whereas the MP dispersion obtained was opaque (designated by “B”).

FIGS. 10A-C present SEM images of the PP (FIG. 10A), PP coated with PNB NPs (FIG. 10B) and PNB MPs (FIG. 10C) films prepared as described in the Example section.

FIGS. 11A-B present SEM images (bars are 4 μm) of the PP (FIG. 11A) and PP/PNB NPs (FIG. 11B) films prepared by melt-compounding, as described in the Example section.

FIGS. 12A-C present FTIR spectra (FIG. 12A) and TGA thermogram (FIG. 12B) of the PP and PP/PNB NPs films prepared as described in the Example section. FIG. 12C is a closer view of FIG. 12B at a temperature range of 320 to 360° C.

FIG. 13 presents ultraviolet-visible (UV-Vis) and absorbance spectra of PP, PP/film former and PP/PNB NPs films. This figure illustrates that the absorbance spectra of the PP and PP with film former is quite similar.

FIG. 14 presents UV-Vis transmission spectra of the PP, PP/film former, PP/PNB NPs and PP/MPs films prepared as described in the Example section. (%, μm) indicates the concentration of the NPs or MPs in the aqueous dispersion (w/v) used for the coating of the PP films and the average wet thickness of the coatings.

FIG. 15 presents average UV-Vis transmittance spectra vs time of PP films and PP/NB & PP/PNB NPs (1 and 2%) films prepared by melt-compounding.

FIG. 16 presents a scheme summarizing exemplary embodiments of UV absorbing coating as disclosed herein.

### DETAILED DESCRIPTION OF THE INVENTION

The present invention, in some embodiments thereof, relates to crosslinked polymeric backbones, and more particularly, but not exclusively, to microsized and nanosized polymeric particles comprising 2-(2′-hydroxy-5′-methacryloxyethylphenyl)-2H-benzotriazole (Norbloc™ (referred to herein as: “NB”) or a derivative thereof, and uses thereof in, for example, UV absorbing films.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

The Composition

According to an aspect of some embodiments of the present invention, there is provided a composition-of-matter comprising a plurality of crosslinked polymeric backbones, the crosslinked polymeric backbones being represented by the general Formula A:

[A₁]ₓ[A₂]_{y}

In some embodiments A₁ is a monomeric unit derived from a compound being represented by the general Formula I:

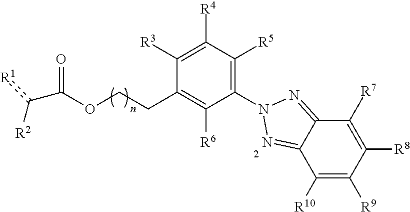

As used herein, the term “polymer” describes an organic substance composed of a plurality of repeating structural units (monomeric units) covalently connected to one another.

In some embodiments, each of R¹-R¹⁰ represents a substituent.

In some embodiments, R¹ is alkyl, substituted or non-substituted; In some embodiments, R¹ is alkene. Dashed lines represents one or double bond.

In some embodiments, R² comprises or is selected from, but is not limited to, hydrogen, alkyl, cycloalkyl, aryl, heteroalicyclic, heteroaryl, alkoxy, hydroxy, thiohydroxy, thioalkoxy, aryloxy, thioaryloxy, amino, nitro, halo, trihalomethyl, cyano, amide, carboxy, sulfonyl, sulfoxy, sulfinyl, and sulfonamide.

In some embodiments, one to four substituents from R³ to R¹⁰, in each instance, comprise hydrogen. In some embodiments, one to four substituents from R³ to R¹⁰, in each instance, comprise alkyl. In some embodiments, one to four substituents from R³ to R¹⁰, in each instance, comprise cycloalkyl. In some embodiments, one to four substituents from R³ to R¹⁰, in each instance, comprise aryl. In some embodiments, one to four substituents from R³ to R¹⁰, in each instance, comprise heteroalicyclic. In some embodiments, one to four substituents from R³ to R¹⁰, in each instance, comprise heteroaryl. In some embodiments, one to four substituents from R³ to R¹⁰, in each instance, comprise alkoxy. In some embodiments, one to four substituents from R³ to R¹⁰, in each instance, comprise hydroxyl. In some embodiments, one to four substituents from R³ to R¹⁰, in each instance, comprise thiohydroxy. In some embodiments, one to four substituents from R³ to R¹⁰, in each instance, comprise thioalkoxy. In some embodiments, one to four substituents from R³ to R¹⁰, in each instance, comprise aryloxy. In some embodiments, one to four substituents from R³ to R¹⁰, in each instance, comprise thioaryloxy. In some embodiments, one to four substituents from R³ to R¹⁰, in each instance, comprise amino. In some embodiments, one to four substituents from R³ to R¹⁰, in each instance, comprise nitro. In some embodiments, one to four substituents from R³ to R¹⁰, in each instance, comprise halo. In some embodiments, one to four substituents from R³ to R¹⁰, in each instance, comprise trihalomethyl. In some embodiments, one to four substituents from R³ to R¹⁰, in each instance, comprise cyano. In some embodiments, one to four substituents from R³ to R¹⁰, in each instance, comprise amide. In some embodiments, one to four substituents from R³ to R¹⁰, in each instance, comprise carboxy. In some embodiments, one to four substituents from R³ to R¹⁰, in each instance, comprise sulfonyl. In some embodiments, one to four substituents from R³ to R¹⁰, in each instance, comprise sulfoxy. In some embodiments, one to four substituents from R³ to R¹⁰, in each instance, comprise sulfinyl. In some embodiments, one to four substituents from R³ to R¹⁰, in each instance, comprise sulfonamide. In some embodiments, one to four substituents from R³ to R¹⁰, in each instance, comprise or are a fused ring.

Herein, in some embodiments, by “one to four substituents from R³ to R¹⁰” it is meant refer to: one substituent, two substituents, three substituents, four substituents, five substituents, six substituents, seven substituents, or, in some embodiments to eight substituents from R³ to R¹⁰

In some embodiments, at least one of R³ to R⁵ is hydroxyl.

In some embodiments, R⁵ is hydroxyl.

In some embodiments, n is an integer having a value from 1 to 5. In some embodiments, n has a value of 1.

In some embodiments, dot lines represent a double bond.

In some embodiments, A₂ represents a second monomeric unit. In some embodiments, the second monomeric unit is derived from a crosslinking monomer (also referred to as: “crosslinker monomer” or “cross-linker”).

In some embodiments, A₂ may represent various types of crosslinkers.

In some embodiments, A₁ is polymerized, or is crosslinked by at least one A₂, via the double bond.

In some embodiments, x and y are integers, independently, representing the total numbers of A₁ and A₂, respectively, in the plurality of crosslinked polymeric backbones.

In some embodiments, x and/or y has a value of at least 5.

In some embodiments, x and y are integers, each independently, having a value from 1 to 3000. In some embodiments, x and y are integers, each independently, having a value from 1 to 1000. In some embodiments, x and y are integers, each independently, having a value from 1 to 3000. In some embodiments, x and y are integers, each independently, having a value from 1 to 1000. In some embodiments, x and y are integers, each independently, having a value from 2 to 10. In some embodiments, x and y are integers, independently, having a value from 5 to 20. In some embodiments, x and y are integers, each independently, having a value from 10 to 50. In some embodiments, x and y are integers, each independently, having a value from 20 to 100. In some embodiments, x and y are integers, each independently, having a value from 50 to 200. In some embodiments, x and y are integers, each independently, having a value from 100 to 300. In some embodiments, x and y are integers, each independently, having a value from 200 to 400. In some embodiments, x and y are integers, each independently, having a value from 300 to 500. In some embodiments, x and y are integers, each independently, having a value from 400 to 500. In some embodiments, x and y are integers, each independently, having a value from 500 to 3000.

In some embodiments, the individual portions designated by m and n may be in any order in the polymeric backbone. By “any order” it is meant to refer to e.g., alternating copolymers with regular alternating monomeric units (designated as “A₁” and “A₂”), or in some embodiments, the polymeric backbone comprises periodic copolymers with A₁ and A₂ units arranged in a repeating sequence (e.g., A₁-A₂-A₁-A₂-A₂-A₁-A₁-A₁-A-A₂-A₂-A₂). In some embodiments, the polymeric backbone comprises statistical copolymers. As used herein, “statistical copolymers” are copolymers in which the sequence of monomer residues follows a statistical rule. In some embodiments, the polymeric backbone comprises block copolymers. As used herein, block copolymers comprise two or more homopolymer subunits linked by covalent bonds.

As used herein, “crosslinked” and/or “crosslinking”, and any grammatical derivative thereof refers generally to a chemical process or the corresponding product thereof in which two chains of polymeric molecules are attached by bridges (crosslinker) composed of an element, a group or a compound, which join certain carbon atoms of the chains by primary chemical.

In some embodiments, the crosslinker is selected from but is not limited to, tetra(ethylene glycol) diacrylate, ethylene glycol and dimethacrylate, divinylbenzene.

In some embodiments, the crosslinked polymers have quite different mechanical and physical properties than their uncrosslinked linear or branched counterparts. For example, crosslinked polymers may show unique and highly desirable properties such as solvent resistance, high cohesive strength, and elastomeric character. Typically, the crosslinked polymers are characterized by a plurality of polymeric strands that may be covalently linked together. The term “polymeric strand” refers to any composition of monomeric units covalently bound to define a backbone.

Typically, but not exclusively, the crosslinking reaction can occur in situ during formation of the polymer.

In the context of the present disclosure, the crosslinker is a compound having at least two double carbon-carbon bonds.

In some embodiments, A₁ is in the form represented by Formula Ib:

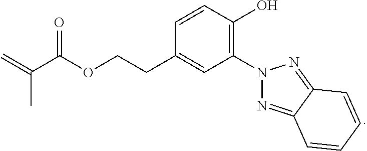 [SMILES: C=C(C)C(=O)OCCc1ccc(O)c(-n2nc3ccccc3n2)c1]

As used herein, “crosslinked” and/or “crosslinking”, and any grammatical derivative thereof refers generally to a chemical process or the corresponding product thereof in which two chains of polymeric molecules are attached by bridges (crosslinker) composed of an element, a group or a compound, which join certain carbon atoms of the chains by primary chemical.

In some embodiments of the present invention, there is provided a composition-of-matter comprising a plurality of crosslinked polymeric backbones, the crosslinked polymeric backbones being represented by the general Formula B:

[A₁]ₓ[A₂]_{y}[A₃]_{z}

In some embodiments, A₃ represents a third monomeric unit, or a polymer derived therefrom, or is absent. In some embodiments, z is an integer representing a value of 1 or more.

Exemplary polymeric unit represented by A₃ are selected from, without being limited thereto: isothiouronium methylstyrene (ITMS) (or a polymer thereof), Formula II:

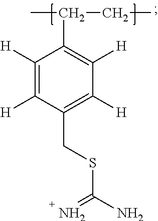

or methylstyrene farmin (MSF) (or a polymer thereof), Formula III:

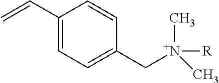

R₁₁, is selected from e.g., hydrogen, alkyl, and cycloalkyl.

In some embodiments A₃ is a combination of isothiouronium methylstyrene (ITMS) (or a polymer thereof) and methylstyrene farmin (MSF) (or a polymer thereof)

The Compositions-of-Matter:

According to an aspect of some embodiments of the present invention there is provided a composition-of-matter comprising a plurality of any one of the polymer represented by Formula A in any embodiment thereof, as described hereinabove, or any combination thereof.

In some embodiments, the composition-of-matter is in the form of one or more particles.

In some embodiments, the composition-of-matter further comprises a stabilizer. In some embodiments, the stabilizer is a surfactant e.g., non-ionic surfactant, anionic surfactant, cationic surfactant and amphiphilic surfactant.

In some embodiments, the stabilizer is selected from the group consisting of Tweens, tritons, tyloxapol, pluronics, Brijcs, Spans, poloxamers and cmulphors.

In some embodiments, the stabilizer is polyvinylpyrrolidone (PVP). In some embodiments, the stabilizer is polysorbate.

In some embodiments, the particles are microsized. In some embodiments, the particles are nanosized.

In some embodiments, the average or median size (e.g., diameter, length) ranges from about 0.1 micrometer to 10 micrometers.

In some embodiments, the average or median size is about 0.15 μm, about 0.2 μm, about 0.3 μm, about 0.4 μm, about 5 μm, about 6 μm, about 7 μm, about 8 μm, about 9 μm, about 10 μm, including any value and size range therebetween.

Hereinthroughout, the terms “nanoparticle”, “nano”, “nanosized”, and any grammatical derivative thereof, which are used herein interchangeably, describe a particle featuring a size of at least one dimension thereof (e.g., diameter, length) that ranges from about 1 nanometer to 100 nanometers. Hereinthroughout, NP(s) designates nanoparticle(s).

In some embodiments, the size of the particles described herein represents an average or median size of a plurality of nanoparticle composites or nanoparticles.

In some embodiments, the average or median size of at least e.g., 10%, 20%, 30%, 40%, 50%, 60%, 70%, 80%, 90%, 95% of the polymeric particles, including any value therebetween, ranges from: about 1 nanometer to 1000 nanometers, or, in other embodiments from 1 nm to 500 nm, or, in other embodiments, from 10 nm to 200 nm, In some embodiments, the average or median size ranges from about 1 nanometer to about 300 nanometers. In some embodiments, the average or median size ranges from about 1 nanometer to about 200 nanometers. In some embodiments, the average or median size ranges from about 1 nanometer to about 100 nanometers. In some embodiments, the average or median size ranges from about 1 nanometer to 50 nanometers, and in some embodiments, it is lower than 35 nm.

In some embodiments, a plurality of the polymeric particles has a uniform size.

By “uniform” or “homogenous” it is meant to refer to size distribution that varies within a range of less than e.g., 60%, 50%, 40%, 30%, 20%, 10%, including any value therebetween.

In some embodiments, plurality of the polymeric particles are characterized by an average hydrodynamic diameter of less than 30 nm with a size distribution of that varies within a range of less than e.g., 60%, 50%, 40,%, 30%, 20%, 10%, including any value therebetween.

In some embodiments, the polymeric particles is about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 40 nm, about 42 nm, about 44 nm, about 46 nm, about 48 nm, or 50 nm, including any value therebetween.

As used herein the term average or median size refer to diameter of the polymeric particles. The term “diameter” is art-recognized and is used herein to refer to either of the physical diameter (also termed “dry diameter”) or the hydrodynamic diameter. As used herein, the “hydrodynamic diameter” refers to a size determination for the crosslinked polymer in solution (e.g., aqueous solution) using any technique known in the art, e.g., dynamic light scattering (DLS).

In some embodiments, the stabilizer affects the particle's size, e.g., with the higher concentration of the surfactant, dictating a smaller sized particles.

As exemplified in the Example section that follows, the dry diameter of the polymeric particles, as prepared according to some embodiments of the invention, may be evaluated using transmission electron microscopy (TEM) or scanning electron microscopy (SEM) imaging.

The polymeric particle(s) can be generally shaped as a sphere, a rod, a cylinder, a ribbon, a sponge, and any other shape, or can be in a form of a cluster of any of these shapes, or can comprises a mixture of one or more shapes.

Substrates and/or Articles:

According to some of any of the embodiments described herein, a composition according to any one of the respective embodiments further comprises a substrate. In some embodiments a plurality of polymeric particles as described in any of the respective embodiments is incorporated in and/or on at least a portion of the substrate.

According to an aspect of some embodiments of the present invention, there is provided a substrate having incorporated in and/or on at least a portion thereof, the disclosed polymeric particles as described herein.

By “a portion thereof” it is meant, for example, a surface or a portion thereof, and/or a body or a portion thereof, of solid or semi-solid substrates; or a volume or a part thereof, of liquid, gel, foams and other non-solid substrates.

In some embodiments, in the composition comprising a substrate, the particles are less than e.g., 30%, by (total) weight. In some embodiments, the particles are less than 25%, by weight. In some embodiments, the particles are less than 20%, by weight. In some embodiments, the particles are less than 15%, by weight. In some embodiments, the particles are less than 10%, by weight. In some embodiments, the particles are less than 5%, by weight. In some embodiments, the particles are less than 4%, by weight. In some embodiments, the particles are less than 3%, by weight. In some embodiments, the particles are less than 2%, by weight. In some embodiments, the particles are less than 1%, by weight.

Substrates of widely different chemical nature can be successfully utilized for incorporating (e.g., depositing on a surface thereof) the disclosed polymeric particles thereon, as described herein. By “successfully utilized” it is meant that (i) the disclosed polymeric particles successfully form a uniform and homogenously coating on the substrate's surface; and (ii) the resulting coating imparts long-lasting desired properties (e.g., antimicrobial properties) to the substrate's surface.

In some embodiments the disclosed polymeric particles form a layer thereof in/on a surface the substrate.

The terms, film/films and layer/layers are used herein interchangeably. As used herein, the term “coat” refers to the combined layers disposed over the substrate, excluding the substrate, while the term “substrate” refers to the part of the composite structure supporting the disposed layer/coating. In some embodiments, the terms “layer”, “film” or as used herein interchangeably, refer to a substantially uniform-thickness of a substantially homogeneous substance.

The chemistry and morphological properties of the layers, e.g., disposed on top of the substrate, are discussed hereinbelow in the Example section. Moreover, according to one embodiment of the present invention, the layer is homogenized deposited on a surface.

In some embodiments, the desired dry thickness of the layer of the disclosed polymer is characterized by a thickness of 0.1 to 100 microns. For example, the thickness of the dry layer may be from about 0.5 microns to about 20 microns. In some embodiments, the dry layer thickness is up to about 50 microns, however thicker or thinner layers can be achieved.

In exemplary embodiments, the dry layer thickness is characterized by a thickness of 1 μm, 2 μm, 3 μm, 4 μm, 5 μm, 6 μm, 7 μm, 8 μm, 9 μm, 10 μm, 11 μm, 12 μm, 13 μm, 14 m or 15 μm, including any value therebetween.

In some embodiments, the term “dry layer thickness” as used herein refers to the layer thickness obtained by storing the composite at room conditions (e.g., at 25° C. and humidity of up to e.g., 60% and measuring the thickness thereof under that condition).

In some embodiments, the wet thickness is characterized by 5 to 200 microns. In exemplary embodiments, the wet layer thickness is characterized by a thickness of 5 μm, 10 μm, 15 μm, or 20 μm, including any value therebetween.

Wet thickness is the thickness as measured after adding a liquid has been added to the composition, as described in the Example section below.

Substrate usable according to some embodiments of the present invention can therefore be hard (rigid) or soft, solid, semi-solid, or liquid substrates, and may take a form of a foam, a solution, an emulsion, a lotion, a gel, a cream or any mixture thereof.

Substrate usable according to some embodiments of the present invention can have, for example, organic or inorganic surfaces, including, but not limited to, glass surfaces; porcelain surfaces; ceramic surfaces; silicon or organosilicon surfaces, metallic surfaces (e.g., stainless steel); mica, polymeric surfaces such as, for example, plastic surfaces, rubbery surfaces, paper, wood, polymer, a metal, carbon, a biopolymer, silicon mineral (rock or glass), surfaces, wool, silk, cotton, hemp, leather, fur, feather, skin, hide, pelt or pelage) surfaces, plastic surfaces and surfaces comprising or made of polymers such as but not limited to polypropylene (PP), polycarbonate (PC), polyethylene (PET), high-density polyethylene (HDPE), low-density polyethylene (LDPE), polyester (PE), unplasticized polyvinyl chloride (PVC), and fluoropolymers including but not limited to polytetrafluoroethylene (PTFE, Teflon®); or can comprise or be made of any of the foregoing substances, or any mixture thereof.

Alternatively, other portions, or the entire substrate are made of the above-mentioned materials.

In some embodiments, the substrate incorporating the polymer as described herein is or forms a part of an article.

Hence according to an aspect of some embodiments of the present invention there is provided an article (e.g., an article-of-manufacturing) comprising a substrate incorporating in and/or on at least a portion thereof a composition-of-matter or the crosslinked polymer, as described in any one of the respective embodiments herein.

The article can be any article which can benefit from the antimicrobial and/or anti-biofilm formation activities of the disclosed polymeric particles.

Exemplary articles include, but are not limited to, medical devices, organic waste processing device, fluidic device, an agricultural device, a package (e.g., a food packaging), a sealing article, a fuel container, a water and cooling system device and a construction element.

Non-limiting examples of devices which can incorporate the halogenated crosslinked polymer, as described herein, beneficially, include tubing, pumps, drain or waste pipes, screw plates, and the like.

In some embodiments, the article is an element used in water treatment systems (such as for containing and/or transporting and/or treating aqueous media or water), devices, containers, filters, tubes, solutions and gases and the likes.

In some embodiments, the article is an element in a waste treatment system, containers, filters, tubes, and the likes.

Physical Characterization:

In some embodiments, the disclosed particles and/or articles, or the composition in any embodiments disclosed herein, are characterized by high light absorption in the ultra-violet (UV) range. As used herein and in the art, the UV range refers to a range of from about 100 nm to about 380 nm or, in some embodiments from about 200 nm to about 380 nm.

In some embodiments, the light absorption of patterns in the ultra-violet (UV) range is less than 60%, in some embodiments less than 50%, in other embodiments less than 40%, in other embodiments less than 30%, and in further embodiments of less than 20% light transparency.

In some embodiments, the light absorption of patterns in the UV range is in the range of 0% to 60%, 0% to 40%, 0% to 30%, 10% to 50%, or 10% to 40%.

In some embodiments, the disclosed particles and/or articles, or the composition in any embodiments as disclosed herein, are characterized by high optic transmission in the visible light range. In some embodiments, the transmission is of visible light, being measured in the wavelength range of about 380 nm to 700 nm. In some embodiments, the transmission is of the NIR and/or IR light. The IR range refers to a range of from about 780 nm and less than about 500 μm (including the near IR at between about 700 nm and about 1300 nm).

Any article that may benefit from the property of high optic absorption in the ultra-violet (UV) range is contemplated.

In some embodiments, the disclosed particles and/or articles, or the composition in any embodiments thereof is characterized by a low haze value.

As used herein, the term “haze” is defined as the fraction of transmitted light which scatters and deviates from the incident beam by more than 2.5°.

In some embodiments, the disclosed polymeric films are characterized by a haze value of low than e.g., 40%, 35%, 30%, 25%, 20%, 15%, 10%, 5%, 4%, 3%, 2%, or 1%.

In some embodiments, the disclosed nanosized particles, or their composition in any embodiments thereof is characterized by an improved property as compared to a reference material. In some embodiments, the reference material is the disclosed microsized particles, or their composition or film in any embodiments thereof.

In some embodiments, by “improved property” it is meant to refer to increased UV transmission by at least e.g., 10%, 20%, or 30% of the nanosized polymeric particles or a coating/film comprising the same having similar thickness and particles concentration, compared to the disclosed microsized polymeric particles.

A exemplified in the Examples section that follows, optimal experimental conditions PP films of maximum 35% UV transmission can be prepared from the PP/PNB MPs.

In exemplary embodiments, films characterized by no UV transmission (100% UV absorption blocking) can be prepared only from the PNB NPs, indicating the advantage of the PNB NPs over MPs for coating of the PP films.

In some embodiments, by “improved property” it is meant to refer to lower haze value of at least e.g., 10%, 20%, 30%, 40%, 50%, 60%, 70%, 80%, or 90%, of the coating/film based on the nanosized polymeric particles compared to the coating/film based on the microsized polymeric particles having a similar thickness and particles concentration.

In some embodiments, by “improved property” it is meant to refer to the clarity of the coating/film based on the nanosized polymeric particles compared to the coating/film based on the microsized polymeric particles having a similar thickness and particles concentration.

In some embodiments, by “improved property” it is meant to refer to anti-fog property. In some embodiments, by “improved property” it is meant to refer to antibacterial property.

In some embodiments, clarity describes the degree to which fine details may be resolved in an object viewed through the film.

In some embodiments, the disclosed polymeric particles is characterized by a thermal stability compared to the corresponding pure (neat) non-polymerized monomeric compounds.

In some embodiments, the thermal stability is expressed by “ΔT” which refers to the difference in thermal degradation/evaporation temperature between the polymeric particles and the corresponding monomers.

In some embodiments, the term “thermal degradation temperature” refers to the onset temperature of 5% degradation/evaporation.

In some embodiments, the term “thermal degradation temperature” refers to the temperature at the point of the thermal gravimetric analysis (TGA) curve, which indicates the point where the degradation/evaporation rate is maximum.

In some embodiments, the thermal stability of the polymeric particles is increased by a defined ΔT.

In some embodiments, ΔT is at least 5, 10, 15, 20, 25, 30, or 40 (° C.) above the thermal degradation temperature of the monomeric compound.

In some embodiments, the disclosed layer is devoid of migration from the substrate.

As used herein and in the art, the term “migration” refers to the escape of additives (e.g., the disclosed particles in the form of a layer) from a polymeric host (e.g., a substrate).

By “devoid of migration” it is meant that e.g., less than 30%, less than 25%, less than 20%, less than 15%, less than 10%, less than 5%, of the disclosed particles are escaped from the substrate.

In some embodiments, the disclosed layer is devoid of migration for at least 1 day, 50 days, 100 days, 200 days, 1 year, 2 years, 3 years, 4 years, 5 years, 10 years.

Processes of Preparing a Polymeric System:

According to an aspect of some embodiments of the present invention there is provided a process of preparing a nanosized PNB and any or any derivative and copolymer thereof as described hereinabove in Formulae A and I.

It is to note that synthesizing such a controlled size of the polymer is subjected to various limitations, imposed by a e.g., different tendency of the monomers to disperse in the solution, complicated desired structural features that are required for optimal size, uniformity, and performance of the crosslinked polymer, incompatibility of the reactants, initiators and the like. Hence, devising a process that overcomes these limitations and is designed to obtain uniform crosslinked polymeric microparticles or nanoparticles that exhibits at least a reasonable performance is highly advantageous.

According to some embodiments, the process comprises emulsion co-polymerization of the vinylic monomer NB or derivative thereof (Formula I) with the crosslinking monomer (for example and without limitation, DVB).

In some embodiments, the process is performed in the presence of a free radical initiator. In some embodiments, the process is performed in the presence of surfactant.

In some embodiments, the process allows to obtain a cross-linked polymer in the form of a particle.

In some embodiments, the polymerization process takes place under emulsion polymerization conditions sufficient to polymerize the monomers of the monomer composition.

In some embodiments, the polymeric process comprises:
(a) dissolving NB or derivative thereof in an organic medium (for example and without limitation, toluene) so as to provide a solution comprising the NB or derivative thereof;
(b) adding the solution to an aqueous solution comprising the free radical initiator and crosslinking monomer (e.g., DVB)

In some embodiments, the aqueous solution comprises a surfactant.

Non-limiting exemplary surfactants are selected from, tween, sodium dodecyl benzene sulfonate.

In some embodiments, the organic phase containing the organic solvent and excess monomers are then extracted from the aqueous phase, optionally followed by removal of the excess surfectant from the aqueous dispersion by any method known in the art (e.g., ultra-filtration).

The polymerization of various monomeric units can be effected by any polymerization method known in the art, e.g., using suitable polymerization initiators and optionally chain transfer agents. Such suitable polymerization initiators and chain transfer agents can be readily identified by a person skilled in the art.

As demonstrated in the Examples section that follows, the polymerization can be performed via a radical polymerization methodology in an aqueous solution.

The term “radical polymerization” or “free radical polymerization” refers to a method of polymerization by which a polymer is formed from the successive addition of free radical building blocks. Free radicals can be formed via a number of different mechanisms usually involving separate initiator molecules. Since the radical polymerization initiator can generate a radical by abstracting hydrogen from a carbon-hydrogen bond, when it is used in combination with an organic material such as a polyolefin a chemical bond can be formed. Following creation of free radical monomeric units, polymer chains grow rapidly with successive addition of building blocks onto free radical sites.

As a radical polymerization initiator for initiated polymerization or redox initiated polymerization, the following exemplary water soluble radical polymerization initiators may be used, without being limited thereto, singly or in a combination of two or more types: peroxides such as ammonium persulfate, potassium persulfate, sodium persulfate, hydrogen peroxide, benzoyl peroxide, cumene hydroperoxide, or di-t-butyl peroxide; a redox initiator that is a combination of the above-mentioned peroxide and a reducing agent such as a sulfite, a bisulfite, thiosulfate, formamidinesulfinic acid, or ascorbic acid; or an azo-based radical polymerization initiator, such as, without limitation, 2,2′-azobis(2-amidinopropane) (AIBN), AIBNCOOH, and 2,2′-azobis(2-amidinopropane), and potassium persulfate (PPS). In exemplary embodiments, the initiator is selected from the group consisting of: PPS and AIBN.

As described hereinabove, it is to be understood that a polymerization process utilizing monomer having a functional group that can form a crosslinked structure.

From the viewpoint of ease of incorporation of the crosslinked structure as described hereinabove under “The Compositions”, the method in which a polymerization reaction is carried out using in combination a crosslinking agent (monomer) having at least two polymerizable double carbon-carbon bonds. Similar crosslinking reaction may be caused by heating at the same time as radical polymerization.

It is to be understood that other radical polymerization methodology can be applied, such as, without limitation, living radical polymerization.

By “living polymerization” it is meant to refer to a form of chain growth polymerization where the ability of a growing polymer chain to terminate has been removed. Living radical polymerization is a type of living polymerization where the active polymer chain end is a free radical.

Several methodologies of living radical polymerization are known in the art and are conceivable to be applied in the context of the present invention, including, without limitation, reversible-deactivation polymerization, catalytic chain transfer, cobalt mediated radical polymerization, iniferter polymerization, stable free radical mediated polymerization, atom transfer radical polymerization, reversible addition fragmentation chain transfer (RAFT) polymerization, iodine-transfer polymerization (ITP), selenium-centered radical-mediated polymerization, telluride-mediated polymerization (TERP), and stibine-mediated polymerization.

In some embodiments, the duration of polymerization process is at least 1 minute. In some embodiments, the duration of polymerization process is at least 30 seconds, at least 1 minute, at least 2 minutes, at least 3 minutes, at least 5 minutes, at least 10 minutes, at least 15 minutes, at least 20 minutes, at least 25 minutes, at least 30 minutes, at least 35 minutes, at least 40 minutes, at least 45 minutes, or at least 50 minutes. In exemplary embodiments, the duration of polymerization process is at least 1 minute, e.g., 1 min, 5 minutes or 30 minutes. Each possibility represents a separate embodiment of the invention.

As described hereinthroughout, the deposition of the polymeric particles on the substrate may be applied by any method known in the art, including, without limitation, bar spreading, immersing, thin coating, melt-mixing, doping and/or dipping of the particles on/with the substrate.

In some embodiments, the incorporation/deposition of the disclosed polymeric particles on the substrate is affected by melt-compounding the substrate or a portion thereof with the disclosed polymeric particles.

The terms “melt-compounding”, “melt-mixing”, or “meld-blending” refer to a process in which at least one molten polymeric substrate (e.g., PP) is intimately mixed with at least one polymeric particle at the processing temperature; the term “processing temperature” refers to the temperature at which melt polymer is carried out, for example, temperature of 50° C., 60° C., 70° C., 80° C., 90° C., 100° C., 110° C., 120° C., 130° C., 140° C., 150° C., 160° C., 170° C., 180° C., 190° C., 200° C., 210° C., 220° C., 230° C., 240° C., 250° C., 260° C., 270° C., 280° C., 290° C., 300° C., 310° C., 320° C., 330° C., 340° C., 350° C., 360° C., 370° C., 380° C., 390° C., 400° C., 410° C., 420° C., 430° C., 440° C., 450° C., 460° C., 470° C., 480° C., 490° C., or 500° C., including any value therebetween. In some embodiments, the meld-blending is performed in an extruder.

In some embodiments, the deposition of the disclosed polymeric particles is assisted by a film former, i.e., applying to a substrate a solution containing primer prior to spreading thereon the polymeric particles.

“Film former” or “film forming agent”, “primer,” as used herein means a compound, e.g., polymer or resin that leaves a film on the substrate to which it is applied, for example, after a solvent accompanying the film former has evaporated, absorbed into and/or dissipated on the substrate.

Non-limiting exemplary film formers are selected from gelatin, alginic acid, polyvinylalcohol/acetate, imine primers, e.g., A-131-X, or any derivative thereof.

### Definitions

As used herein, the term “alkyl” describes an aliphatic hydrocarbon including straight chain and branched chain groups. Preferably, the alkyl group has 21 to 100 carbon atoms, and more preferably 21-50 carbon atoms. Whenever a numerical range; e.g., “21-100”, is stated herein, it implies that the group, in this case the alkyl group, may contain 21 carbon atom, 22 carbon atoms, 23 carbon atoms, etc., up to and including 100 carbon atoms. In the context of the present invention, a “long alkyl” is an alkyl having at least 20 carbon atoms in its main chain (the longest path of continuous covalently attached atoms). A short alkyl therefore has 20 or less main-chain carbons. The alkyl can be substituted or unsubstituted, as defined herein

The term “alkyl”, as used herein, also encompasses saturated or unsaturated hydrocarbon, hence this term further encompasses alkenyl and alkynyl.

The term “alkenyl” describes an unsaturated alkyl, as defined herein, having at least two carbon atoms and at least one carbon-carbon double bond. The alkenyl may be substituted or unsubstituted by one or more substituents, as described hereinabove.

The term “alkynyl”, as defined herein, is an unsaturated alkyl having at least two carbon atoms and at least one carbon-carbon triple bond. The alkynyl may be substituted or unsubstituted by one or more substituents, as described hereinabove.

The term “cycloalkyl” describes an all-carbon monocyclic or fused ring (i.e. rings which share an adjacent pair of carbon atoms) group where one or more of the rings does not have a completely conjugated pi-electron system. The cycloalkyl group may be substituted or unsubstituted, as indicated herein.

The term “aryl” describes an all-carbon monocyclic or fused-ring polycyclic (i.e., rings which share adjacent pairs of carbon atoms) groups having a completely conjugated pi-electron system. The aryl group may be substituted or unsubstituted, as indicated herein.

The term “alkoxy” describes both an —O-alkyl and an —O-cycloalkyl group, as defined herein.

The term “aryloxy” describes an —O-aryl, as defined herein.

Each of the alkyl, cycloalkyl and aryl groups in the general formulas herein may be substituted by one or more substituents, whereby each substituent group can independently be, for example, halide, alkyl, alkoxy, cycloalkyl, alkoxy, nitro, amine, hydroxyl, thiol, thioalkoxy, thiohydroxy, carboxy, amide, aryl and aryloxy, depending on the substituted group and its position in the molecule. Additional substituents are also contemplated

The term “halide”, “halogen” or “halo” describes fluorine, chlorine, bromine or iodine.

The term “haloalkyl” describes an alkyl group as defined herein, further substituted by one or more halide(s).

The term “haloalkoxy” describes an alkoxy group as defined herein, further substituted by one or more halide(s).

The term “hydroxyl” or “hydroxy” describes a —OH group.

The term “thiohydroxy” or “thiol” describes a —SH group.

The term “thioalkoxy” describes both an —S-alkyl group, and a —S-cycloalkyl group, as defined herein.

The term “thioaryloxy” describes both an —S-aryl and a —S-heteroaryl group, as defined herein.

The term “amine” describes a —NR′R″ group, with R′ and R″ as described herein.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine.

The term “heteroalicyclic” or “heterocyclyl” describes a monocyclic or fused ring group having in the ring(s) one or more atoms such as nitrogen, oxygen and sulfur. The rings may also have one or more double bonds. However, the rings do not have a completely conjugated pi-electron system. Representative examples are piperidine, piperazine, tetrahydrofurane, tetrahydropyrane, morpholino and the like.

The term “carboxy” or “carboxylate” describes a —C(═O)—OR′ group, where R′ is hydrogen, alkyl, cycloalkyl, alkenyl, aryl, heteroaryl (bonded through a ring carbon) or heteroalicyclic (bonded through a ring carbon) as defined herein.

The term “carbonyl” describes a —C(═O)—R′ group, where R′ is as defined hereinabove.

The above-terms also encompass thio-derivatives thereof (thiocarboxy and thiocarbonyl).

The term “thiocarbonyl” describes a —C(═S)—R′ group, where R′ is as defined hereinabove.

A “thiocarboxy” group describes a —C(═S)—OR′ group, where R′ is as defined herein.

A “sulfinyl” group describes an —S(═O)—R′ group, where R′ is as defined herein.

A “sulfonyl” or “sulfonate” group describes an —S(═O)₂—R′ group, where Rx is as defined herein.

A “carbamyl” or “carbamate” group describes an —OC(═O)—NR′R″ group, where R′ is as defined herein and R″ is as defined for R′.

A “nitro” group refers to a —NO₂ group.

A “cyano” or “nitrile” group refers to a —C≡N group.

As used herein, the term “azide” refers to a —N₃ group.

The term “sulfonamide” refers to a —S(═O)₂—NR′R″ group, with R′ and R″ as defined herein.

The term “phosphonyl” or “phosphonate” describes an —O—P(═O)(OR′)₂ group, with R′ as defined hereinabove.

The term “phosphinyl” describes a —PR′R″ group, with R′ and R″ as defined hereinabove.

The term “alkaryl” describes an alkyl, as defined herein, which substituted by an aryl, as described herein. An exemplary alkaryl is benzyl.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine. The heteroaryl group may be substituted or unsubstituted by one or more substituents, as described hereinabove. Representative examples are thiadiazole, pyridine, pyrrole, oxazole, indole, purine and the like.

As used herein, the terms “halo” and “halide”, which are referred to herein interchangeably, describe an atom of a halogen, that is fluorine, chlorine, bromine or iodine, also referred to herein as fluoride, chloride, bromide and iodide.

The term “haloalkyl” describes an alkyl group as defined above, further substituted by one or more halide(s).

General:

As used herein the term “about” refers to ±10%.

The terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

### Example 1

### Materials and Methods

Chemicals

The following analytical-grade chemicals were used without further purification: 2-(2′-hydroxyl-5′-methacryloxyethylphenyl)-2H-benzotriazole (Norbloc 7966, NB), divinyl benzene (DVB, 80%), potassium persulfate (PPS), sodium dodecylbenzene sulfonate (SDBS), polyvinylpyrrolidone (PVP, m.w. 360,000), benzoyl peroxide (BP), 2-methoxyethanol and toluene from Sigma-Aldrich. PP films (O₂ corona treated) of A₄ size and 30 μm average thickness from Dor Film Ltd, Israel. A-131-X film former (primer) (composed of modified polyethylenimine dissolved in an aqueous solution) from MICA Corporation, Shelton, Conn., USA. Water was purified by passing deionized water through an Elgastat Spectrum reverse osmosis system, Elga Ltd, High Wycombe, UK.

Hand coater (Mayer rod) was purchased from RK Print Coat Instruments Ltd, Litlington, Royston.

Methods

Synthesis of PNB NPs/MPs:

PNB NPs of 19±2 nm dry diameter were prepared by emulsion co-polymerization of the vinylic monomer NB with the crosslinking monomer DVB according to the following procedure: 90 mL of a toluene solution containing 17.64 g of NB were added to 240 mL aqueous solution containing: 3 g SDBS, 330 μL DVB and 0.9 g of PPS. The mixture was then shaken at 73° C. for 18 h. The organic phase containing the toluene and excess monomers was then extracted from the aqueous phase, followed by removal of the excess SDBS from the aqueous dispersion by ultra-filtration with a Viva flow 200 system (Sartorius AG, Goettingen, Germany).

PNB MPs of 200±25 nm dry diameter were synthesized by dispersion co-polymerization as described in the literature [Goldshtein, J.; Margel, S. Polymer (Guildf). 2009, 50, 3422-3430.]. Briefly, 22.6 g NB, 10 g PVP, 1.28 mL DVB and 1 g BP were dissolved in 500 mL 2-methoxyethanol. The mixture was then shaken at 73° C. for 18 h. The formed PNB MPs were then washed from excess reagents by intensive centrifugation cycles with ethanol and water.

Thin Coatings of the PNB NPs or MPs onto PP Films:

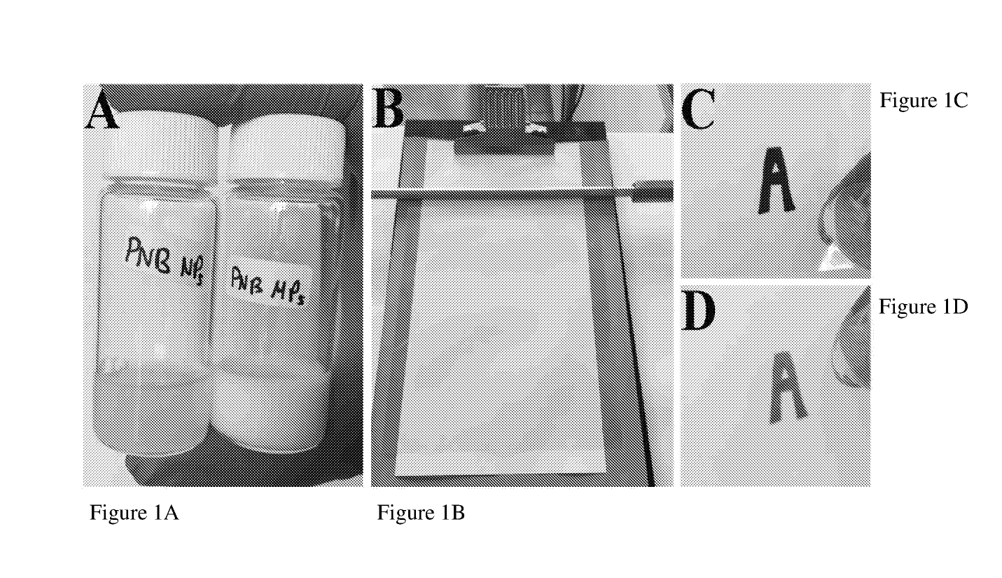

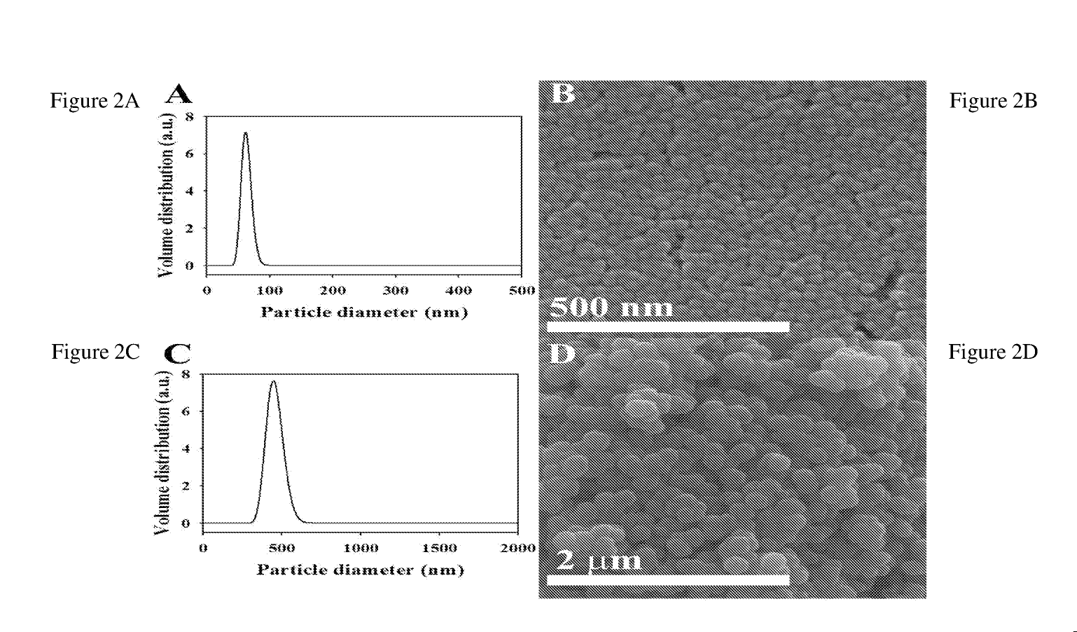

PP/PNB NPs films (FIG. 1C) were prepared by mixing 4% PNB NPs aqueous dispersion (FIG. 1A) with 4% aqueous solution of the film former A-131-X (1:1 v/v), or by mixing 8% PNB NPs aqueous dispersion with 4% aqueous solution of the film former (1:1 v/v). The obtained 2% or 4% PNB NPs aqueous dispersion in the A-131-X polymer former aqueous solution was then spread on the 30 μm PP films (O₂ corona treated) with a Mayer rod (FIG. 2B), followed by drying the PNB NPs coating on the PP films for 3 min at 80° C. PP/PNB MPs films (FIG. 2D) were prepared similarly, by mixing 4% PNB MPs aqueous dispersion (FIG. 2A) with 4% aqueous solution of the polymer former (1:1 v/v). The obtained 2% PNB MPs aqueous dispersion in the A-131-X aqueous solution was then used for coating the PP films as described above for the PNB NPs.

Characterization of NB, PNB NPs/MPs and PP/PNB NPs/MPs Films:

Hydrodynamic particle size and size distribution of the PNB NPs or MPs dispersion in water were determined by dynamic light scattering (DLS) with photon cross-correlation spectroscopy (Nanophox particle analyzer, Sympatec GmbH, Germany). The mean dry diameter was determined by scanning electron microscopy (SEM) (JEOL, JSM-840 Model, Japan), by measuring 200 NPs or MPs using an image analysis software (AnalySIS Auto, Soft Imaging SystemGmbH, Germany). SEM images of the various films were obtained with a FEI SEM model Inspect S (JEOL, JSM-840 Model, Japan). For this purpose, coated and uncoated PP films were spread on a glass surface. The samples were then coated with iridium at reduced pressure before being viewed by SEM. UV-Vis spectra of the films in the range 200-600 nm were determined in absorption and transmission modes, using a Cary 5000 spectrophotometer (Agilent Technologies Inc.). Average UV absorbance and transmission were calculated over the range of 280-380 nm. Fourier Transform InfraRed (ATR-FTIR) analysis was performed using a Bruker platinum-FTIR QuickSnap™ sampling module A220/D-01. Powder X-ray Diffraction (XRD) patterns were recorded using an X-ray diffractometer (model D8 Advance, Bruker AXS) with Cu-Kα radiation. The thermal behavior of NB, PNB NPs and MPs and the PP/PNB NPs and MPs films were measured by thermogravimetric analysis (TGA) (TGA/DSC 1 STARe System, Mettler Toledo, Switzerland). The analysis was performed with approximately 10 mg of dried samples or films under an inert atmosphere at a heating rate of 10° C./min.

Film thicknesses were measured on a Millitron 1204 IC (Mahr Feinmesstechnik GmbH). The optical parameters transmittance, haze and clarity of the films were measured on a BYK Gardner haze-gard plus in accordance with ASTM D1003 “Standard Test Method for Haze and Luminous Transmittance of Transparent Plastics”. Mean values and standard deviations of transmittance, haze, and clarity were obtained by taking the average over several measurements (at least 4 measurements each).

Migration Test:

Migration over time was determined by measuring the absorbance and transmission spectra of the PP/NB, PP/PNB NPs and PP/PNB MPs films stored at room temperature for 2, 4, 6, 10, 14, 20, 24 and 36 months. Accelerated migration tests of the PP/PNB NPs or MPs films were also performed by incubating a specimen of 0.5 dm² of each sample in 50 ml of 95% ethanol or 3% acetic acid for 2 h at 60° C. Absorbance and transmission spectra of the various dried films in the range of 200-600 nm before and after the test were then taken.

### Example 2

### Results

Characterization of the PNB NPs and MPs:

The hydrodynamic diameter of the PNB NPs dispersed in water was measured to be 54±6 nm, as illustrated by the typical DLS measurement shown in FIG. 2A. The dry diameter of these NPs was measured to be 19±2 nm as illustrated by the SEM image shown in FIG. 2B. The difference in the particle size between these two methods are due to the fact that the SEM measurements determine the dry diameter, whereas light scattering measurements determine the hydrodynamic diameter, which takes into account swollen water molecules, water layers adsorbed on the particles' surface and Brownian motion. Similarly, the hydrodynamic and dried size and size distribution of the PNB MPs were measured to be 420±40 nm and 200±25 nm, respectively.

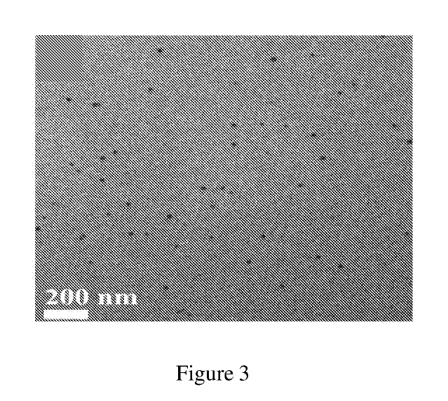

The dry diameter of these NPs was measured to be 19±2 nm as illustrated by typical TEM photo micrograph shown in FIG. 3.

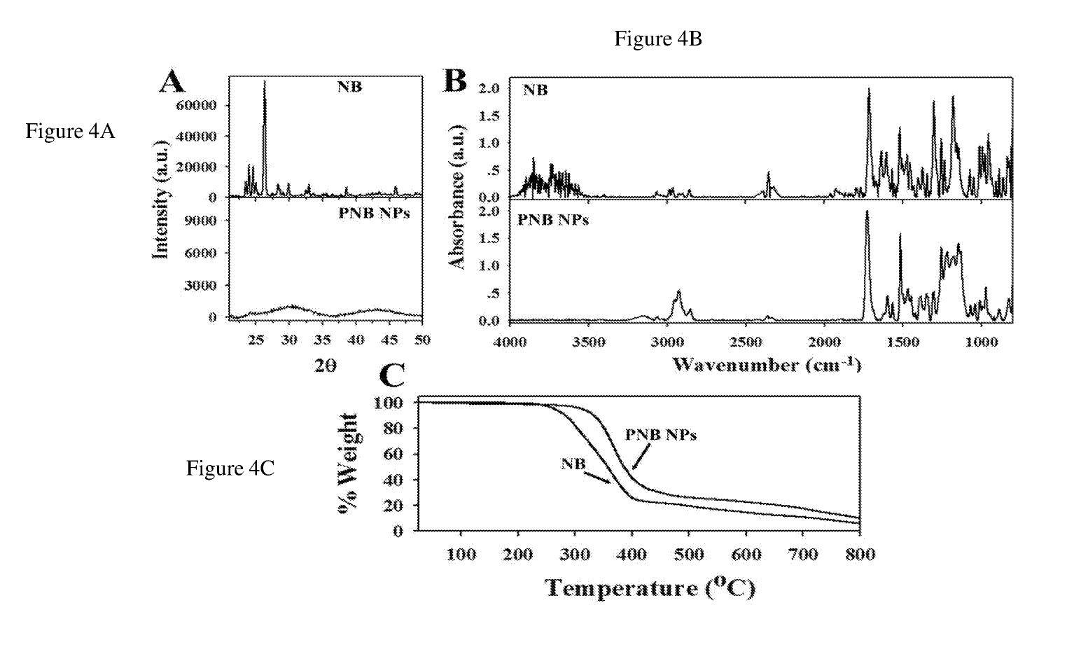

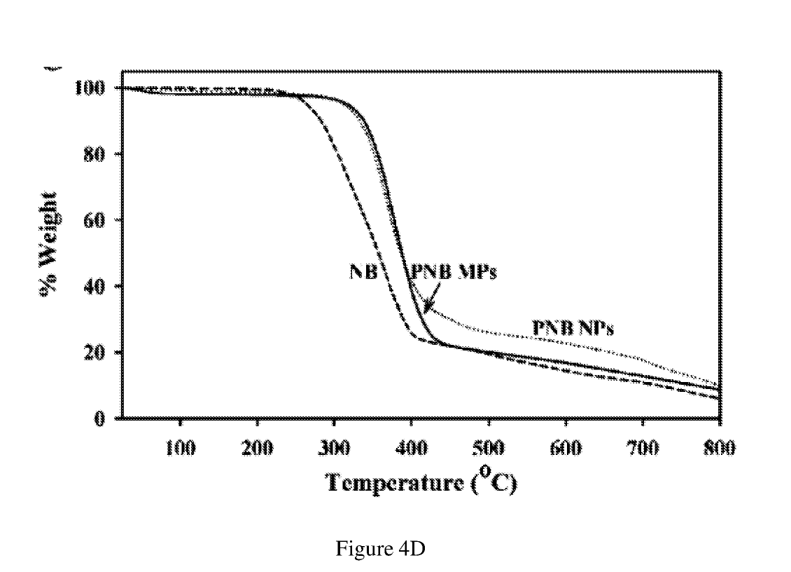

FIG. 4A illustrates XRD patterns of the monomer NB and the PNB NPs. The XRD pattern of the NB monomer displays clear sharp and narrow diffraction peaks typical for crystalline materials. The XRD spectrum of the PNB NPs on the other hand, reveals a very poor diffraction pattern with two very broad peaks in the region between 20=25°-35° and 20=37-50°, indicating an amorphous phase of the PNB NPs. Same XRD pattern was also observed for the PNB MPs. These results indicate the destruction of the crystalline structure of the NB monomer probably due to the radical polymerization mechanism of this monomer.

FIG. 4B presents FTIR absorption spectra between 400 and 4000 cm⁻¹ of the NB monomer and the PNB NPs. The FTIR spectrum of the PNB NPs is similar to that of the NB monomer, except for the disappearance of the vinylic double bond peak at 1650 cm⁻¹ and the broadening and shifting of the carbonyl peak from 1720 cm⁻¹ to 1740 cm⁻¹. The disappearance of the NB double bond is due to the efficient NB polymerization. The difference in the carbonyl stretching band peak location of the NB and the PNB NPs is due to the different chemical character of these carbonyls: the carbonyl of the NB monomer is conjugated to the vinylic double bond while that of the polymer is not. The broadening of the polymeric carbonyl peak as opposed to the monomeric one is due to the inhomogeneous chemical environment of the polymeric carbonyl group compared to that of the monomer. Additionally, the absorption peaks at about 953 and 991 cm⁻¹ corresponding to the vinylic C—H bending band and the peak at 3,742 cm⁻¹ corresponding to the vinylic C—H stretching band, shown for the NB monomer and not for the PNB NPs, indicating also the lack of residual monomer within the polymeric NPs. Instead, after polymerization there is a peak that appears at 2,926 cm⁻¹ corresponding to aliphatic C—H stretching band. Similar FTIR spectrum to that of the PNB NPs was observed, as expected, for the PNB MPs.

The thermal stability is important factor when use the substance as an additive to polymer matrices. The thermal stability of NB monomer and PNB NPs was evaluated by TGA, as illustrated in FIG. 4C. The PNB NPs degrade rapidly over a narrow temperature range, 315-415° C. (mass loss of 70 wt %), followed by a slow degradation process over a wider temperature range, 410-580° C. (mass loss 70-90 wt %). Similar TGA behavior was observed for the PNB MPs (see FIG. 4D). The NB monomer displays a similar degradation behavior (80% weight loss) but at a lower temperature range 280-410° C., indicating higher thermal stability of the PNB NPs or MPs compared to the NB monomer.

Effect of Polymerization Parameters on the Size and Size Distribution of the PNB NPs:

Emulsion polymerization in the presence of a crosslinking monomer is a common method for preparing non-porous NPs in a single-step. In this technique monomers, initiator and stabilizer form an inhomogeneous system resulting in particle formation.

Effect of Initiator Concentration:

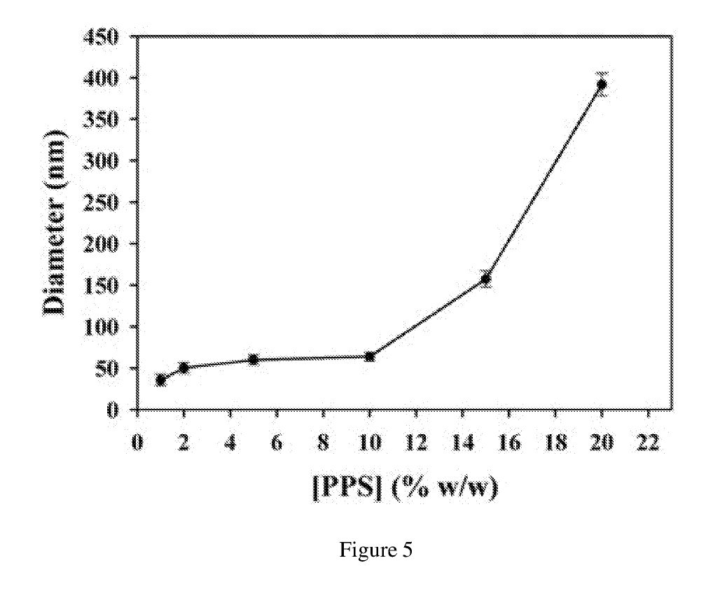

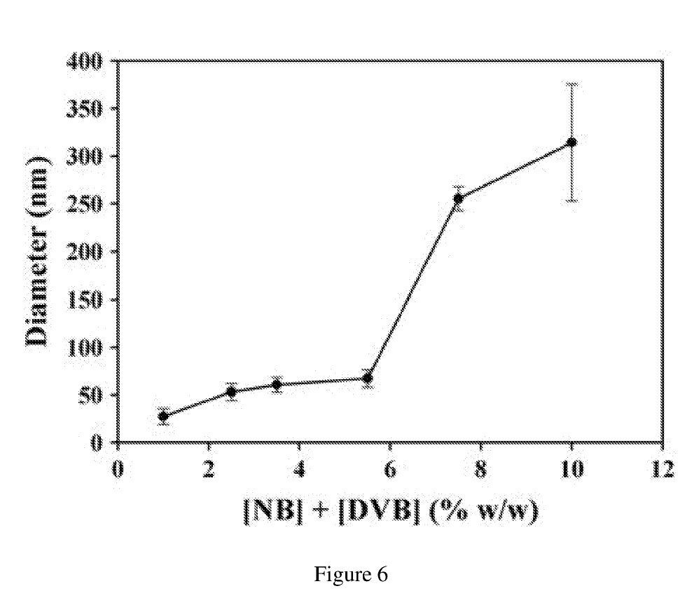

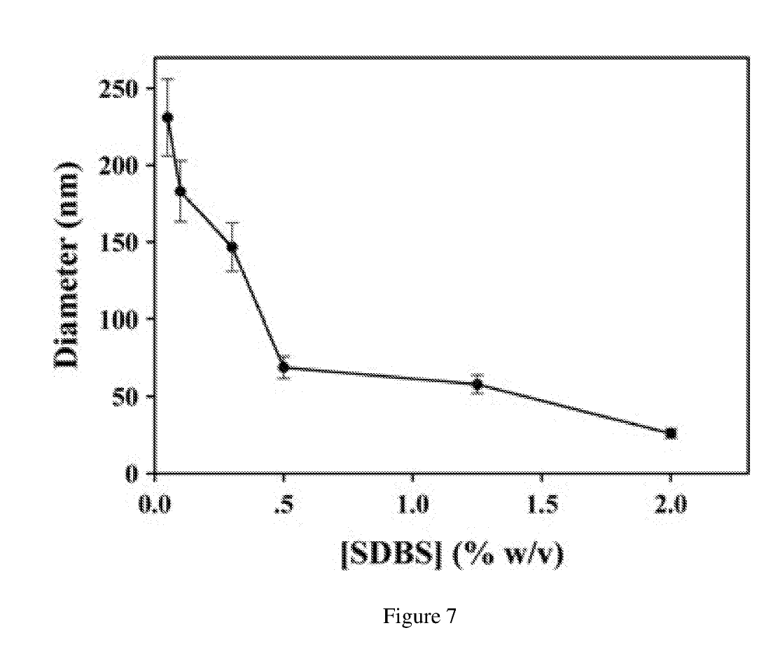

The effect of the PPS concentration on the size and size distribution of the PNB NPs is shown in FIG. 5. It can be seen that increasing the PPS concentration leads to an increase in the diameter and size distribution of the formed PNB NPs. For example, raising the PPS concentration from 2 to 10 and 20% increases the particle size and size distribution from 50±6 to 60±7 and 157±10 nm, respectively. Without being bound by any particular mechanism, it is assumed that the accepted explanation lies in the fact that the increased initiator concentration leads to an increase of oligo-radical formation in the emulsion, thus increasing the probability of collision and coagulation, resulting in larger sized particles. It is possible to assume that increasing of oligo-radical concentration produces a larger number of smaller particles.

Effect of Total Monomer Concentration:

The effect of total monomer concentration ([NB]+[DVB]) on the diameter and size distribution of the PNB NPs showed that increasing the total monomer concentration leads to the formation of larger PNB NPs with higher size distributions as shown. For example, an increase in the total monomer concentration from 1 to 7.5 and 10% leads to an increase in the size and size distribution of the PNB NPs from 28±8 to 256±12 and 314±61 nm, respectively.

Effect of Surfactant Concentration:

The effect of the SDBS concentration on the dry diameter and size distribution of the formed PNB NPs showed that increasing the SDBS concentration leads to the formation of smaller PNB NPs with narrower size distributions, as shown in FIG. 5. For example, raising the SDBS concentration from 0.1 to 0.5 and 2% decreases the particle size and size distribution from 183±20 to 68±7 and 26±3 nm, respectively.

Effect of Crosslinker Concentration:

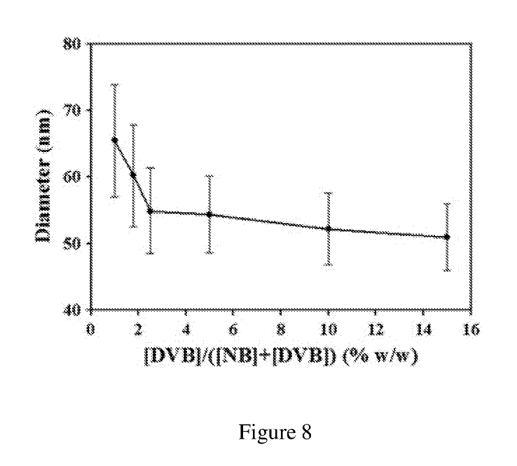

The effect of the weight ratio [DVB]/([NB]+[DVB]) on the hydrodynamic diameter and size distribution of the formed PNB NPs was studied while retaining a constant total monomer ([NB]+[DVB]) concentration. Increasing the weight ratio of [DVB]/([NB]+[DVB]) results in a slight decrease in diameter and size distribution of the formed PNB NPs, as shown in FIG. 8. For example, raising the ratio from 1 to 2.5 and 10 decreases the particle size and size distribution from 65±8 to 55±6 and 52±5 nm, respectively. Without being bound by any particular theory, it is assumed that this behavior may be explained by the fact that increasing the crosslinker concentration leads to the formation of more crosslinked nuclei, thereby decreasing the ability of the growing nuclei to grow by monomer swelling, resulting in smaller sized particles.

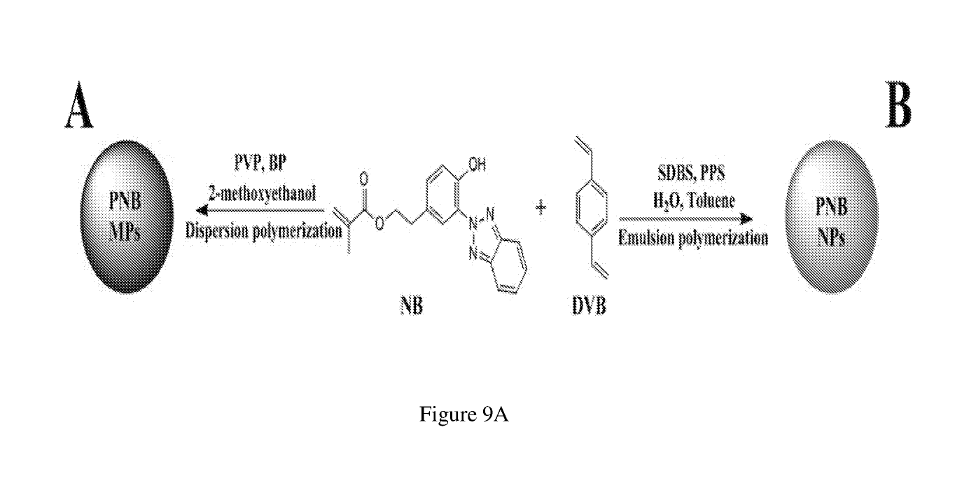

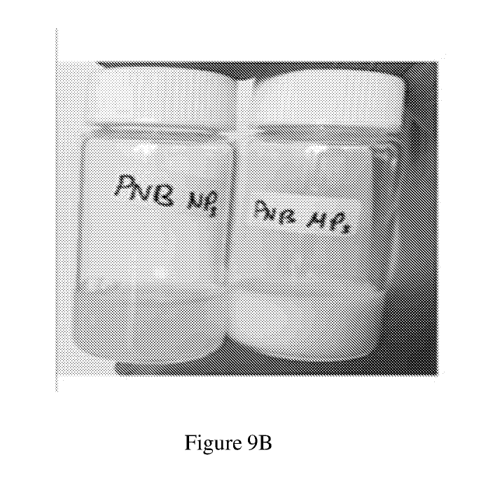

FIG. 9 presents scheme summarizing the synthesis of the PNB NPs/MPs: PNB NPs were prepared by emulsion co-polymerization of the vinylic monomer NB with the crosslinking monomer DVB in the presence of SDBS as the surfactant and potassium persulfate as the initiator in I-120 as the continuous phase. That is, the emulsion polymerization formed a translucent dispersion of NPs, whereas the dispersion polymerization process, as anticipated, gave an opaque dispersion of MPs.

NB was co-polymerized with divinylbenzene by emulsion and dispersion polymerization processes to obtain PNB nanoparticles and microparticles, respectively (designated by “A”). The emulsion polymerization resulted in a translucent NP dispersion, whereas the MP dispersion obtained was opaque (designated by “B”).

Thin Coatings of PNB NPs and MPs onto PP Films:

UV absorbing PP films were prepared by thin coating of the PNB NPs or MPs onto the PP films, as described in the experimental part. The coating of the PNB NPs onto the PP films was done with 2 and 4% (w/v) of the PNB NPs dispersion in the polymer former aqueous solution. The coating of the PNB MPs was done only with 2% (w/v) of the PNB MPs dispersion in the polymer former aqueous solution, since the 4% PNB MPs aqueous dispersion was not stable due to a fast agglomeration process. Coatings of different thicknesses were accomplished with the Mayer rod hand coater providing 6, 12 and 24 μm wet average thicknesses, or 1, 2, and 4 μm, respectively dry average thicknesses.

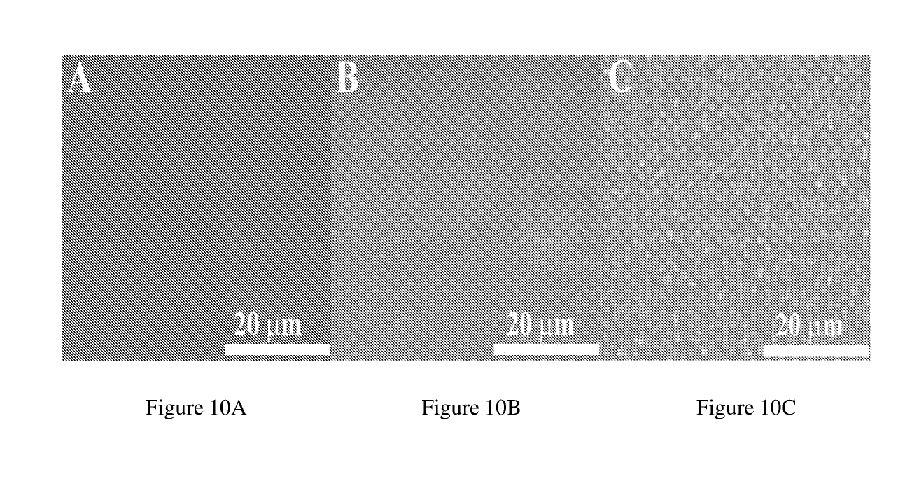

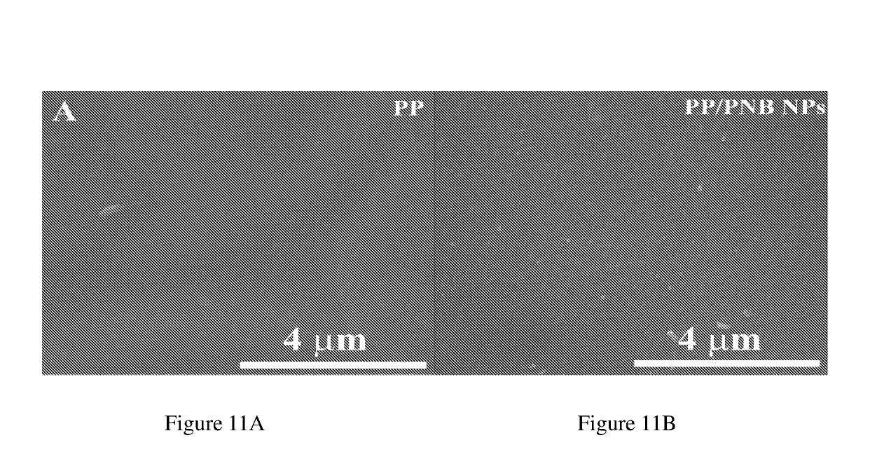

FIGS. 10A-C and 11A-B show SEM images of the PP, PP/PNB NPs and PP/PNB MPs films with coatings of 12 μm average wet thickness. It is clearly seen that the NPs coating yielded a smooth surface, while the film coated with the MPs appears quite rough. This roughness probably disrupts the optical properties of the PP film.

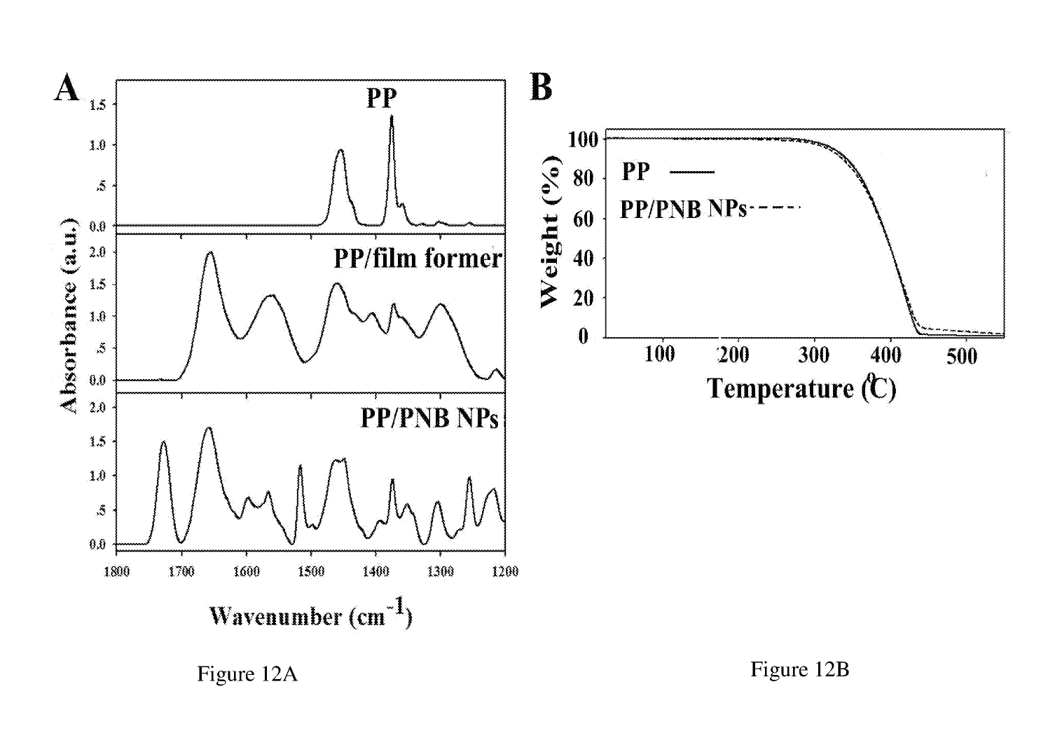

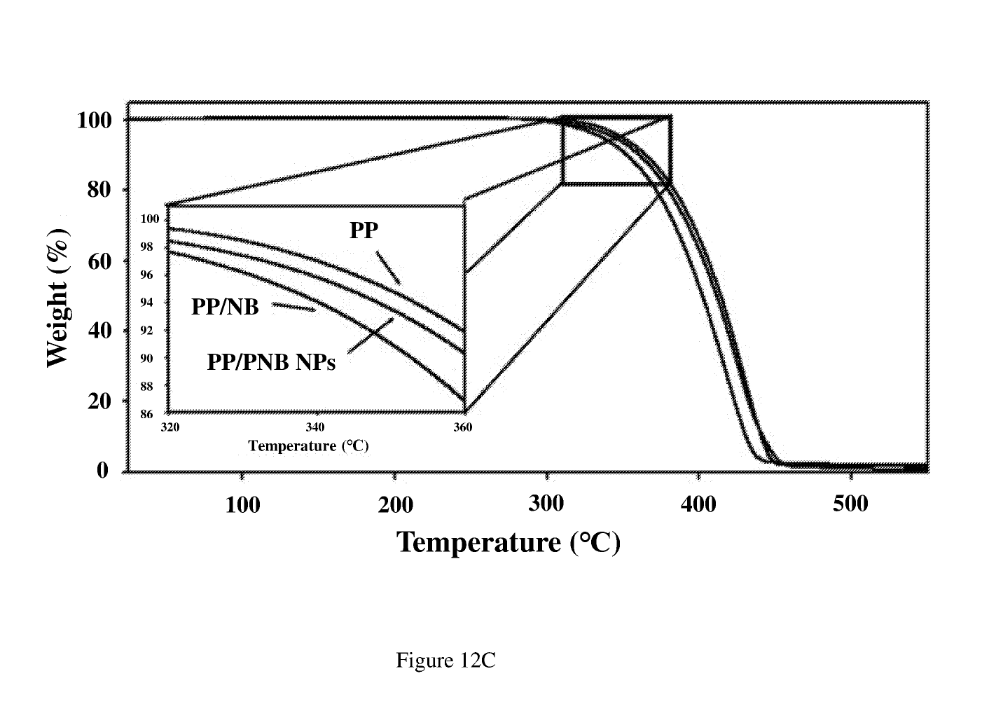

FIG. 12A presents typical FTIR absorption spectra of the PP, PP/polymer former and PP/PNB NPs films (12 μm wet thickness). The FTIR absorption spectra of the PP/PNB NPs films contain peaks characteristic to PP, polymer former and PNB NPs. The absorption peaks of the PP/PNB NPs films at 1728 cm⁻¹ corresponding to the carbonyl stretching band of the PNB NPs, the absorption peaks at about 1375 and 1455 cm⁻¹ corresponding to the C—H bending band of methyl pendant group of PP and the absorption peaks at 1655 cm⁻¹ corresponding to N—H bending band of polyethylenimine belonging to the polymer former. Similar FTIR spectrum to that of the PP/PNB NPs was observed, as expected, for the PP/PNB MPs films.

The thermal stability of the PP and PP/PNB NPs films were evaluated by TGA, as shown in FIGS. 12B and 12C. This figure illustrates that the PP and the PP/PNB NPs films possess similar degradation behavior, i.e., rapid degradation over a narrow temperature range, 315-415° C. (mass loss of 98 wt %), indicating that the surface coating of the PNB NPs onto the PP films has no significant effect on the thermal properties of the PP films. Same TGA behavior was observed for the PP/PNB MPs. These results may indicate that the PNB NPs and MPs dispersion in the film former aqueous solution are well dispersed and compatible with the PP films.

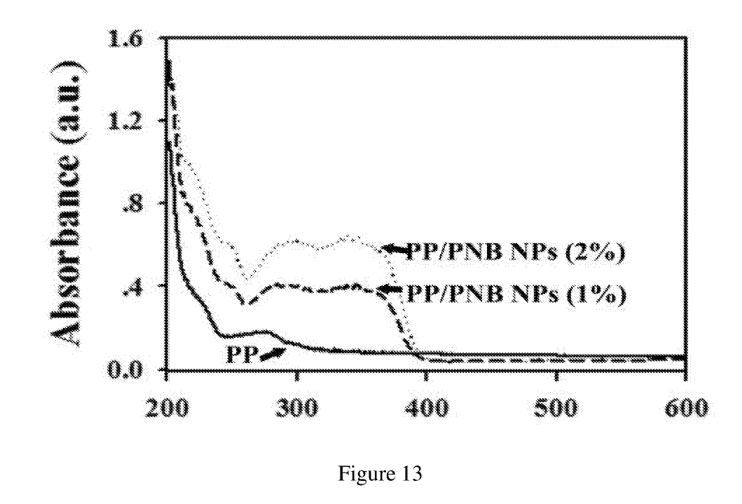

FIG. 13 shows UV-Vis absorbance spectra of PP, PP/A-131-X and PP/PNB NPs films. This figure illustrates that the absorbance spectra of the PP and PP/A131-X is quite similar.

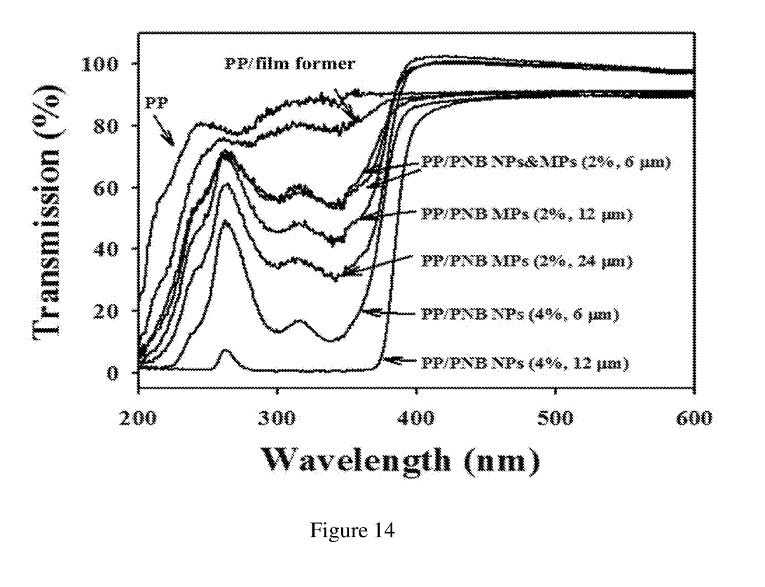

FIG. 14 shows the UV-Vis transmission spectra of PP, PP/film former, PP/PNB NPs and PP/PNB MPs films. This figure shows that the visible transmission of all the films is similar and high, between 85-95%, while the UV transmission is dependent on the coating type. The UV transmission of the PP and PP/polymer former films is high, about 85 and 75%, respectively. The coating of the PP films with the PNB NPs or MPs leads to a significant decrease in the UV transmission. Increasing the concentration of the PNB particles or the coating thickness led to appropriate decrease in the % UV transmission. For example, thin coatings of 2% PNB MPs of 6, 12 and 24 μm wet thickness onto PP films decreased the UV transmission of the PP from 95% to 60, to 45 and 35%, respectively. Similar results were obtained by substituting the 2% PNB MPs for 2% PNB NPs. Coatings of the PP films with 4% PNB particles in the aqueous polymer former solution could be achieved only with the PNB NPs as mentioned previously. FIG. 14 indicates that coatings of 4% PNB NPs of 6 and 12 μm wet thickness decreased the UV transmission of the PP films from 95% to 20 and 0%, respectively.

To summarize, under optimal experimental conditions PP films of maximum 35% UV transmission could be prepared from the PP/PNB MPs while films of no UV transmission (100% UV absorption blocking) could be prepared only from the PNB NPs, indicating the advantage of the PNB NPs over MPs for coating of the PP films.

Migration is the term used for the escape of additives from a polymeric host and may limit the use of additives in the plastic. Crosslinked particles may overcome this disadvantage, due to their insolubility and large spatial structure, which reduces their migration while maintaining the activity. Same absorbance and transmittance spectra of the PP/PNB NPs or PP/PNB MPs films were observed over 3 years of storage at room temperature, indicating that there is no migration during this time period. No migration was also observed when the PP/PNB NPs or PP/PNB MPs films were immersed at 60° C. in 95% ethanol or in 3% aqueous acetic acid for 2 h.

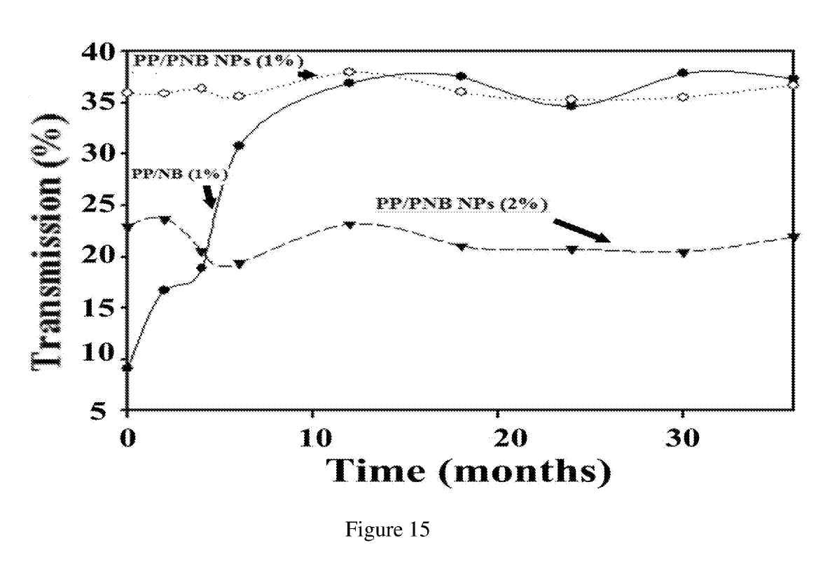

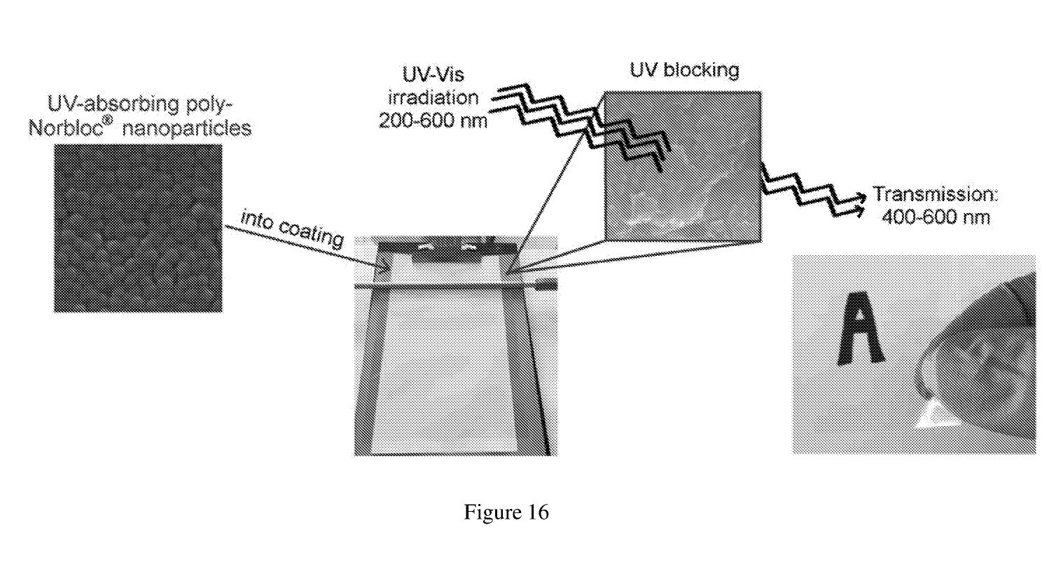

However, a significant migration of NB was observed for the PP/NB films containing 1% of NB monomer, as shown in FIG. 15, e.g., within approximately 10 months the % UV transmission increased from 10% to 35%. Furthermore, when the PP/NB (1%) films were immersed at 60° C. in 95% ethanol for 2 h a complete migration of the NB from the films to the solvent was observed.

Haze is defined as the fraction of transmitted light which scatters and deviates from the incident beam by more than 2.5°. High haze values indicate that an object will appear milky or cloudy, when viewed through the film. Clarity describes the degree to which fine details may be resolved in an object viewed through the film. High clarity values are associated with a clear and sharp image of the object. As the clarity values decrease, the object seen through the film appears out of focus and blurry. Total transmitted visible light is the percentage of light passing through the film (including the scattered light after transmittance). For some applications, the optical properties of polymeric films are important, for example in transparent food packaging. The haze, clarity and transmittance of the various PP films are shown in Table 1, presenting the optical properties of the PP, PP/film former, PP/PNB NPs and PP/PNB MPs films.

Desired optical properties were observed for the PP/PNB NPs coated films. The NPs are small enough and well dispersed and highly transparent films were observed, indicating the potential use of the PP/PNB NPs as transparent films. In addition, there was no change in the optical properties of the various films after 3 years of storage at room temperature. Similar values of clarity and transmission were observed for the PP/PNB MPs films as for the PP/PNB NPs films. On the other hand, higher haze values were observed for the PP/PNB MPs films compared to that of the PP/PNB NPs films, 33.9±6.05 and 3.2±0.3%, respectively, indicating the superior optical properties of the PP/PNB NPs films over the PP/PNB MPs films of similar thickness and particles concentration.

TABLE 1

| | | | Transmission |
|---|---|---|---|
| Film type | Haze (%) | Clarity (%) | (%) |
| PP film | 3.18 ± 0.35 | 93.3 ± 0.22 | 96.3 ± 0.22 |
| former coated PP film | 3.22 ± 0.63 | 96.3 ± 0.21 | 91.9 ± 0.22 |
| 4% NP coated film (1 μm) | 3.54 ± 0.40 | 96.6 ± 0.41 | 91.0 ± 0.49 |
| 4% NP coated film (2 μm) | 3.82 ± 0.91 | 96.9 ± 0.12 | 91.1 ± 0.08 |
| 2% NP coated film (1 μm) | 3.2 ± 0.3 | 93.8 ± 0.1 | 95.3 ± 0.24 |
| 2% MP coated film (1 μm) | 33.9 ± 6.05 | 96.8 ± 0.08 | 92.3 ± 0.58 |
| 2% MP coated film (2 μm) | 24.2 ± 13.3 | 96.4 ± 0.64 | 91.9 ± 0.25 |
| 2% MP coated film (4 μm) | 41.8 ± 6.25 | 96.8 ± 0.09 | 91.4 ± 0.24 |

PP, PP/film former, PP/PNB NPs and PP/PNB MPs films were prepared according to the description in the experimental part. (%, μm) indicates the concentration of the NPs or MPs in the aqueous dispersion (w/v) used for the coating of the PP films and the average wet thickness of the coatings

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A composition-of-matter comprising a plurality of crosslinked polymeric backbones, said crosslinked polymeric backbones being represented by the general Formula A:
[A₁]ₓ[A₂]_{y}
wherein:
(a) A₁ is a monomeric unit derived from a compound being represented by the general formula I: 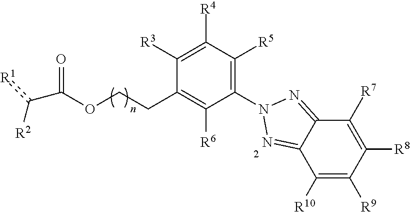
wherein each of R¹-R¹⁰ represents a substituent, such that:
R¹ is alkyl, substituted or non-substituted;
R² to R¹⁰, in each instance, comprise or are selected from the group consisting of hydrogen, alkyl, cycloalkyl, aryl, heteroalicyclic, heteroaryl, alkoxy, hydroxy, thiohydroxy, thioalkoxy, aryloxy, thioaryloxy, amino, nitro, halo, trihalomethyl, cyano, amide, carboxy, sulfonyl, sulfoxy, sulfinyl, sulfonamide, or is a fused ring;
n is an integer having a value from 1 to 5;
dot lines represent a double bond; and
(b) A₂ represents a cross-linker monomeric unit,
wherein A₁ is polymerized, or is cross linked by at least one A₂, via said double bond;
x and y are integers, independently, representing the total numbers of A₁ and A₂, respectively, in said plurality of crosslinked polymeric backbones, wherein said x and y each has a value of at least 5.

2. The composition-of-matter of claim 1, wherein at least one of R³ to R⁵ is hydroxyl.

3. The composition-of-matter of claim 1, wherein A₁ is in the form represented by Formula Ib:

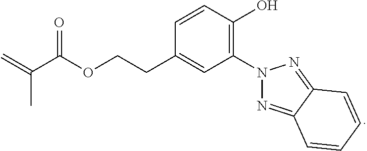 [SMILES: C=C(C)C(=O)OCCc1ccc(O)c(-n2nc3ccccc3n2)c1]

4. The composition-of-matter of claim 1, wherein said cross linker is selected from the group consisting of: tetra(ethylene glycol) diacrylate, ethylene glycol and dimethacrylate, divinylbenzene.

5. The composition-of-matter of claim 1, being in the form of at least one particle.

6. The composition-of-matter of claim 5, wherein said particle is characterized by at least one dimension thereof having a size selected from (i) a size of less 100 nm; and (ii) a size of 100 nm to 500 nm.

7. (canceled)

8. The composition-of-matter of claim 5, wherein at least 80% of a plurality of said particles is characterized by a size that varies within a range of less than 20%.

9. The composition-of-matter of claim 6, further comprising a substrate, wherein a plurality of said particles is incorporated or coated in/on at least a portion of said substrate.

10. (canceled)

11. The composition-of-matter of claim 9, wherein said substrate is selected from the group consisting of polypropylene (PP), polycarbonate (PC), polyethylene (PE), polyethylene terephthalate (PET), high-density polyethylene (HDPE), low-density polyethylene (LDPE), polyester (PE), and any combination thereof.

12. The composition-of-matter of claim 9, wherein a plurality of said particle forms a layer in/on a surface of said substrate.

13. (canceled)

14. The composition-of-matter of claim 12, wherein said layer is provided by a means selected from: bar spreading, immersing, thin coating, melt-mixing, doping and/or dipping of said particles on/with said substrate.

15. The composition-of-matter of claim 12, wherein the layer is characterized by a dry thickness of 0.5 to 20 microns.

16. The composition-of-matter of claim 12, characterized by light transparencies in the range of 0% to 40% at 200 nm to 380 nm wavelength.

17. The composition-of-matter of claim 16, characterized by a stable pattern of said light transparencies, said stable pattern varying within an average range of less than ±20% for a period of at least five years.

18. The composition-of-matter of claim 9 wherein said plurality of said particle is less than 4%, by total weight.

19. The composition-of-matter of claim 11, characterized by a haze value of less than 5%.

20. The composition-of-matter of claim 9, wherein said substrate is or forms a part of an article.

21. The composition-of-matter of claim 20, wherein said article is food packaging.

22. The composition-of-matter of claim 1, further comprising a plurality of crosslinked polymeric backbones, being represented by the general Formula B:
[A₁]ₓ[A₂]_{y}[A₃]_{z}
wherein A₃ represents a monomeric unit selected from the group consisting of isothiouronium methylstyrene (ITMS), methylstyrene farmin (MSF), methylstyrene farmin (MSF), wherein z is an integer, having a value of 1, or more.
